(19) United States
(12) Patent Application Publication
(10) Pub. No.: US 2010/0232877 A1
(43) Pub. Date: Sep. 16, 2010

(54) HEATING SYSTEM AND RELATED METHODS

(75) Inventors: Charles W. Sanvik, St. Michael, MN (US); James A. Olson, New London, MN (US); Shawn R. Yurczyk, St. Cloud, MN (US)

Correspondence Address: SCHWEGMAN, LUNDBERG & WOESSNER, P.A., P.O. BOX 2938, MINNEAPOLIS, MN, 55402, US

(73) Assignee: Green Power Technology, Inc., Waite Park, MN (US)

(21) Appl. No.: 12/504,172

(22) Filed: Jul. 16, 2009

Related U.S. Application Data
(60) Provisional application No. 61/210,049, filed on Mar. 13, 2009.

(51) Int. Cl. E01C 7/06; G05D 23/00; G05B 15/00

(52) U.S. Cl. 404/77; 700/300; 700/275

(57) ABSTRACT

A method and a system for heating such as ground heating or curing concrete.

### CLAIM OF PRIORITY

This non-provisional application claims the benefit of priority under 35 U.S.C. §119(e) to U.S. Provisional Patent Application Ser. No. 61/210,049, filed Mar. 13, 2009, entitled “Heating System and Related Methods,” the specification of which is herein incorporated by reference in its entirety.

### TECHNICAL FIELD

The present application relates generally to the technical field of heating systems, for example, ground heating systems or concrete curing systems.

### BACKGROUND

Construction during cold weather can be difficult when temperatures are below freezing, and the ground is frozen. In such situations, it is necessary to temporarily heat the ground in order for construction such as excavation to occur. Furthermore, the cold weather can affect the ability or the rate of curing of materials such as concrete, so it is necessary to heat concrete pours in cold weather conditions to prevent it from freezing and to control the cure time.

Conventional heaters can provide sufficient heat for the thawing of the ground, and curing concrete, however these heaters are not reliable or cost effective and can be difficult to operate.

### SUMMARY

A system is described herein that provides for elevating or controlling temperatures. The system includes a heating system, a heat distribution assembly operatively coupled with the heating system, and a monitoring system operatively coupled with the heat distribution assembly and the heating system. The monitoring system is operatively connected with a network, where a third party can obtain information regarding the heating system or the heat distribution assembly via the network. In an option, the monitoring system monitors at least temperature at one or more zones of the heat distribution assembly, and/or includes information regarding a predictive cure rate. In a further option, the monitoring system includes one or more wireless sensors associated with at least one zone.

In another option, a system includes a heating system, a heat distribution assembly including one or more zones, one or more sensors associated with at least one zone, and a monitoring system in communication with the one or more sensors.

In an option, the system further includes a control system configured to control temperature at one or more of the zones. In another option, the system includes one or more wireless sensors associated with each zone. In yet another option, the system includes a remote manifold. In yet another option, the system further includes two or more boilers adapted to modulate on and off, where, optionally, the boilers are modulated on and off after a predetermined temperature has been sensed in the ground, and/or in the system.

A method includes heating one or more zones with a system, monitoring one or more zones of the system with a monitoring system, where the system includes a heating system, a heat distribution assembly, and one or more sensors associated with at least one zone. The method further includes sensing temperature at the one or more zones, and monitoring includes monitoring temperature of the one or more zones. In an option, monitoring includes monitoring via a network, and/or monitoring via the network includes accessing information over the internet, or receiving one or more messages from the monitoring system. In a further option, the method includes generating a report regarding temperatures at the one or more zones, monitoring components of the heating system, or receiving an alert when a predetermined value is detected.

In another embodiment, a method of thawing ground or curing material includes heating an area with a heating system, the area including one or more zones, where heating the area includes distributing heat to the area with a heat distribution assembly. The method further includes monitoring at least one parameter of one or more zones with a monitoring system via a network, receiving control signals from a server over a network, modifying the temperature, and returning signal to the server indicating the temperature was modified.

In an option, modifying includes selectively modifying a temperature in each of the zones, modifying the temperature with a manifold, and/or modifying the temperature with a remote manifold. In another option, monitoring includes sensing information with a sensor, and sending a wireless signal regarding the information.

A method of thawing ground or curing material includes connecting tubing to a manifold, circulating fluid through the tubing, depressurizing the tubing with a depressurizing device, and disconnecting the tubing from the manifold after the tubing is depressurized.

In an option, depressurizing the tubing includes opening an actuator, where the actuator is disposed over at least a portion of a tubing connection. In another option, the method further includes closing an actuator of the depressurizing device prior to circulating fluid through the tubing. In yet another option, the method further includes preventing disconnecting the tubing from the manifold until the tubing is depressurized.

In another embodiment, a field cure tester includes an insulated enclosure with heating element therein. One or more forms can be placed within the insulated enclosure. In an example use of the field cure tester, the forms are filled with material to be cured, such as concrete for a ‘test pour’. The insulated enclosure is closed, and a heating fluid is flowed through a heat transfer hose. The heating fluid can be provided from the system discussed above, or the tester can have an independent source of heating fluid. The temperature within the field cure tester is monitored, for instance with a sensor within the insulated enclosure, and further optionally communicated with the system, and in a further option controlled by the system. The temperature can be optionally regulated by modifying the temperature and/or rate of the heating fluid through the heat transfer hose, which is optionally done using the system. At one or more predetermined time intervals, the forms of concrete are broken, tested, and evaluated for information. In a further option, the information can be used to predict the cure rate of the ‘actual pour’.

### BRIEF DESCRIPTION OF THE DRAWINGS

Some embodiments are illustrated by way of example and not limitation in the figures of the accompanying drawings in which:

FIG. 1 is a perspective view of a curing/thawing system constructed in accordance with at least one embodiment.

FIG. 2 is a block diagram of a curing/thawing system constructed in accordance with at least one embodiment.

FIG. 3 is a perspective view of a portion of the curing/thawing system in accordance with at least one embodiment.

FIG. 4 is a perspective view of a portion of the curing/thawing system in accordance with at least one embodiment.

FIG. 5 is a perspective view of a portion of the curing/thawing system in accordance with at least one embodiment.

FIG. 6 is a block diagram of a curing/ thawing system constructed in accordance with at least one embodiment.

FIG. 7 is a block diagram of a computer system constructed in accordance with at least one embodiment.

FIG. 8 is a perspective view of a field tester constructed in accordance with at least one embodiment.

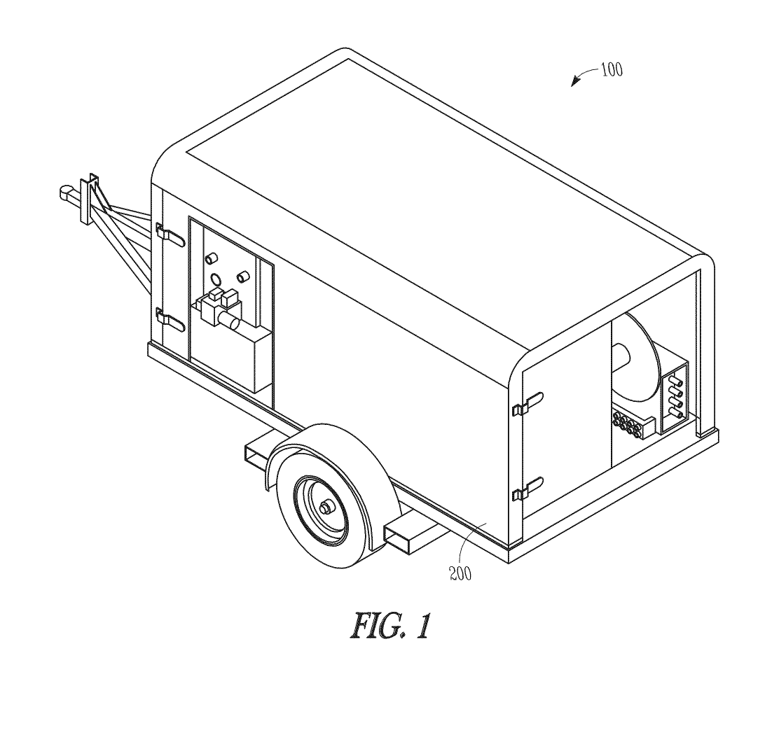

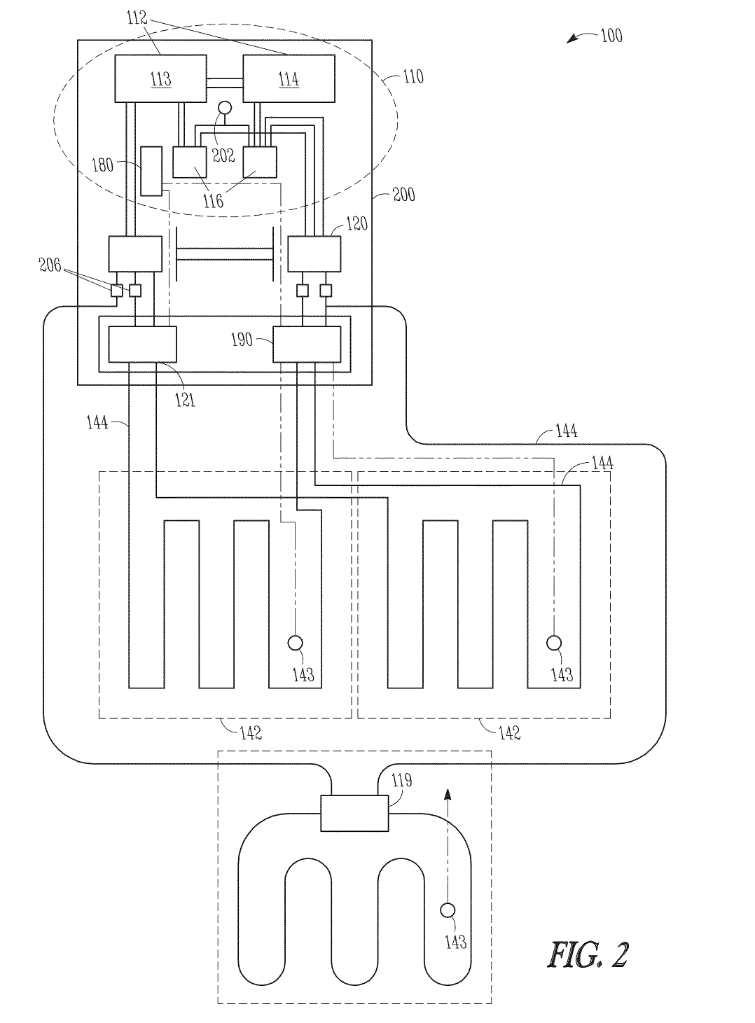

### DETAILED DESCRIPTION

Example methods and systems to thaw ground, curing material such as concrete, testing curing of concrete at a field site, and/or accessing information related to thawing and/or curing are described. In the following description, for purposes of explanation, numerous specific details are set forth in order to provide a thorough understanding of example embodiments. It will be evident, however, to one skilled in the art that the embodiments may be practiced without these particular specific details.

In an embodiment a system 100 is provided for ground thawing and/or curing materials, such as concrete. The system includes heating system 110, a heat distribution assembly 140, and optionally a monitoring system 180 including a controller 190. The monitoring system 180 optionally includes information regarding a predictive cure rate. The system 100 further includes a transport assembly 200, such as a trailer. The transport assembly 200 can be used to transport equipment, such as the heating system 110 and/or heat distribution assembly 140 to a job site. The transport assembly 200 further optionally can be used to monitor the location of the equipment, and/or store equipment.

The heating system 110 includes heat generating equipment, such as, but not limited to, one or more boilers 112. Other types of heat generating equipment can but used including a frictional heater, or a magnetic heater. In an option, the heating system includes at least a first boiler 113 and a second boiler 114. Having at least two boilers such as, but not limited to, the first boiler 113 and the second boiler 114 allows for the equipment to be used where heating is modulated between the first boiler 113 and the second boiler 114. For example, the first boiler 113 is used to generate heat for a period of time, and then the second boiler 114 can be used for a period of time. In an example, the boilers 113, 114 can be regulated to modulate on and off after the sensors have detected the deepest level of the ground is at a particular temperature, such as 32 degrees F., for instance to enter a ground frost prevention mode. For instance, the one or more boilers 112, or the first boiler 113 and the second boiler 114 can be cycled on and off, for instance, depending on a sensed temperature of the ground. This prevents the ground from re-freezing once it has been thawed. This will also assist in maintaining equal longevity of the boiler life as the boilers will optionally run in about equal amounts of time during operation, should only one of the boilers be necessary to run. This will also save fuel as no unnecessary heating takes place. In a further option, the efficiency of the boilers can be improved, for example, by pre-heating the diesel fuel used for the burners.

The system 110 further includes a heat distribution assembly including circulating pumps 116, at least one manifold 120, and an optional remote manifold 119, and tubing 144. In an option, the at least one manifold 120 is removable from the transport assembly 200. The manifold 120 is used to distribute and/or control the heating fluid flow through the system. The manifold 120 can include electronic valve control, for example when the system is set up to be used for a curing system, where a controller is used to control the valves of the manifold 120. In another option, the manifold 120 can be a basic manifold, for example without electronic valve control. The system 110 further includes a hose reel, such as a removable hose reel, that includes the tubing 144 for use with the manifold 120. The hose reel can be based in the transport assembly 200, and is optionally removable from the transport assembly 200.

In an option, the system includes a remote manifold 119 allowing for the manifold 119 to be used remotely from the transportation assembly 200, which allows for larger job sites to be heated with the system 100, or can be used with additional tubing 144 to reach otherwise hard to reach areas at a job site. For instance, the remote manifold 119 can be removed from the transport assembly 200 or the trailer, and used with or without an optional remote and portable hose reel, and moved to a location remote from the trailer, for instance at a location where the trailer cannot be located, such as a rough terrain. In an option, manifold 120 can be removed from the transport assembly 200 and used as a remote manifold 119. The remote manifold 119 can be used for split thaws with the zones of the system. In a further option, the remote manifold 119 further can include zone control features 142 as discussed above and below. The remote manifold 119 in a further option responds to the system such that the system operates the zone control features 142, for instance with electronic valve controls. The remote manifold 119 can be used with remote, portable hose reels to lay out additional zones, which allows for larger cure applications.

The manifold 120 and/or the remote manifold 119, in a further option, can include one or more sensors such as, but not limited to a temperature sensor. The manifold 120 can further be used, along with the controller 190 and the monitoring system 180, to monitor and to control temperature at the various zones 142 independently, for example by using the valves and controlling the flow rate of heating fluid that is distributed to the various zones 142. In a further option, the system further includes concrete maturity prediction software which can calculate the strength of concrete and further assist in functions of temperature control and timing of heat distribution. In yet another option, the system can be used to control the temperature in the last phase of cure to incrementally decrease the temperature of the concrete to ambient temperature. This assists in preventing shock to the concrete when removing blankets at the end of the cure. During operation of the system, the manifold 120 and/or the remote manifold 119 are coupled with the tubing 144, where the tubing 144 allows material such as a heating fluid to flow therethrough.

The tubing 144 is configured at the job site to create one or more zones where the tubing lies on the concrete slab or ground. In an example, the system includes one or more temperature controlled zones, such as one to at least eighteen temperature controlled zones 142. In an option, each zone 142 is independently coupled with a supply and return of a manifold. The zones can be formed of, for example but not limited to, 700 foot loops of tubing 144, where optionally six loops are stored in an enclosed trailer on a hose reel. The various zones 142 can be independently controlled and/or monitored with the manifold 120 and the controller 190.

In addition, the various zones 142 are independently monitored for one or more of ground temperature, ambient temperature, pressure, power, etc. using sensors 143. One or more sensors 143 are associated with one or more, or each of the zones 142. The sensors 143 can be provided along the tubing 144, positioned in, on, or near the ground, or can be embedded in concrete. The sensors 143, in an option, are removable after use, for example, by placing the sensor 143 within a sheath prior to embedding the sensor, and removing the sensor 143 from the sheath after the project has been completed. In an option, sensor and power wires are attached, for example by shrink wrap, to the tubing 144 leading out from the system.

The sensors 143, for example, provide information about a surface, such as surface temperature or information about the material in which it is embedded, such as temperature of the concrete. In an option, the ground temperature monitoring can be done by disposing sensors in holes that are drilled into the ground at multiple locations. This will allow for the ground thawing to be monitored as it occurs, and the system can be modified accordingly.

The sensors 143 provide information about each zone with respect to temperature and/or other parameters and can communicate information to the monitoring system 180, for example wirelessly. For instance, in an option, the sensor 143 is a thermal resistive sensor which sends a wired, or wireless signal to a controller. In an option, information from the sensors 143 is used to control the temperature of the various zones independently, for example by controlling the fluid directed to the zones using a controller. In an option, an average of the concrete temperature in each zone is calculated with ambient temperature. This information is used to selectively modify the temperature at each of the zones as is desired. For instance, the boiler temperature can be increased or decreased, flow to the individual zones can be controlled, a mixing valve can also be used, or a combination thereof.

In a further option, the system 100 includes a depressurization device 200 that allows for depressurization of the system prior to coupling the tubing 144 to the manifold 120. In a further option, the depressurization device 200 allows for depressurization of the tubing 144 prior to disconnection of the tubing 144 from the manifold, such that the fluid within the tubing 144 is not retained under pressure. Various examples of the depressurization device 200 are shown in FIGS. 3-5.

Referring to FIGS. 3 - 5, the depressurization device 200 is associated with the manifold 120, and includes a depressurization switch 202 and an actuator 204. The depressurization device further includes solenoid valves 203 associated with the couplers 121. The depressurization device 200, in an option, includes a mechanism, such as the actuator 204.

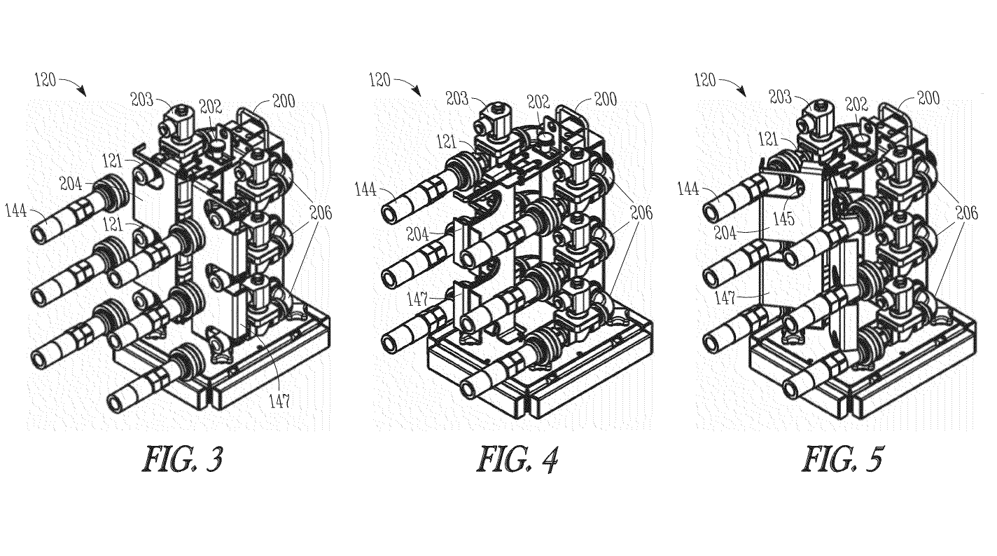

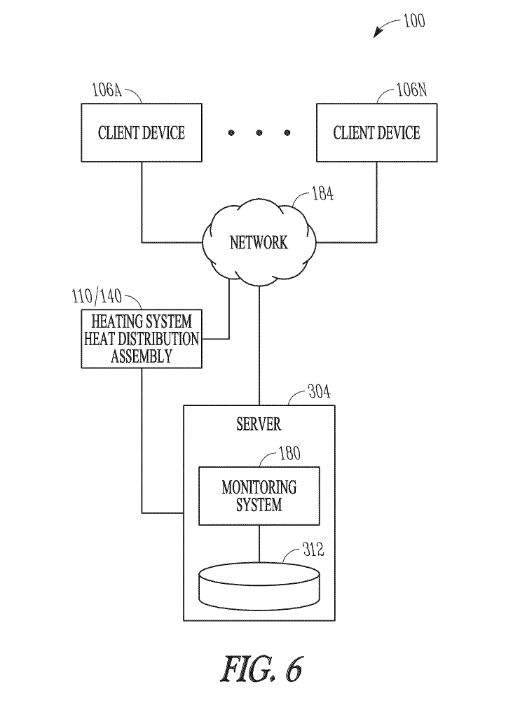

FIG. 3 illustrates a view where the tubing 144 cannot be coupled unless the actuator 204 is opened, and optionally the system is depressurized. FIG. 4 illustrates when the actuator 204 is opened, the system is depressurized, and the tubing 144 can be attached to the manifold 120. This occurs after the actuator 204 is moved out of position in order to connect the tubing 144 with couplers 121 of the manifold 120. For instance, in an option, the actuator 204 includes one or more flanges 147 having coupler cut outs 145 therein. The actuator 204 is spring loaded and is placed in a closed position after and/or as a result of the tubing 144 being coupled with the couplers 121, as shown in FIG. 5. The actuator 204 prevents the tubing 144 from being removed from the couplers 121 until the switch 202 is actuated. For example, the coupler cut outs 145 allow for the actuator to be placed in close proximity to the couplers when the actuator is in the closed position, and the actuator 204 blocks access to the couplers 121 or otherwise prevents removal of the tubing 144 from the manifold 120 until a user places the actuator in an open position, as shown in FIG. 4.

When the actuator 204 is opened, the depressurization switch 202 is actuated. The depressurization device 200 further includes valves 206 operatively coupled with the supply and return of the manifold 120. In an option, the vales 206, for example, solenoid valves, are used to depressurize the tubing 144. A solenoid switch is coupled with the control panel, which is operatively coupled with the power supply, allowing for the power supply to the supply 124 and return 126 to be disconnected. The depressurization of the system allows for a user to safely couple and uncouple the tubing 144 since the tubing 144 is no longer under pressure during the coupling and/or the uncoupling process.

By allowing closer supervision of the temperatures during the curing process, further efficiencies can be achieved at the job site. For example, more fly ash can be used in concrete by creating warm weather condition during winter construction, when typically fly ash is not able to be used. The ability to use fly ash in concrete results in less hazardous landfill use and provides more eco friendly concrete. In addition, with fly ash, less pollution is generated to produce concrete, as well as less water is used and energy is saved. A product including fly ash, slag and/or silica fumes further can provide a stronger, less permeable, and more durable product.

Monitoring the parameters of the system, such as temperatures of the various zones allows for more efficient use of energy to cure concrete and thaw ground because the heating system can accurately monitor and control the use of energy needed to thaw and cure. The system can also alert the contractor when curing is occurring at a rate other than desired and can avoid delays in construction. In addition, the contractor can be alerted when a predetermined value is detected, or if power to the system fails.

During an example use of the system 100 at a job site for thawing, the site is prepared by removing snow, ice, and debris. The site is measured for proper placement of the hose configuration and the insulative blanket 160. The hose is spaced, for example, depending on if excavation is to occur, or if concrete is to be poured. In an example, the hose is spaced 18-24 inches in on the center. The various zones for the hose are created. A vapor barrier can be placed under the hose to contain moisture content in the concrete to allow heat transfer into the slab. One or more insulative blankets are placed over the vapor barrier and/or tubing, where the blankets are optionally placed in a cross-cross pattern. In a further option, weights are placed on the seams of the blankets which assist in preventing the wind from lifting the blankets. The heat system is operatively coupled with the hose and the system is activated for the heating. This system can further be used for curing concrete, or in any application. The system can further be monitored and/or modified remotely as further described below.

FIG. 6 illustrates a system for remote monitoring and controlling the heating system 110 and the heat distribution assembly 140, according to some example embodiments. In particular, FIG. 6 illustrates a server 304, client devices 306A-306N and the heating system 110 and the heat distribution assembly 140, which are coupled together through a network 184. The client devices 306 can include one to any number of such devices coupled to the network 184. While one server and one heating system 110 are shown, example embodiments can include any number of such servers and systems.

In a further option, the system includes self diagnostic capabilities, including an interface for communication regarding the self diagnostics. For example, parameters of components or status of the components of the system are monitored. For instance, examples of self diagnostics include, but are not limited to, warnings regarding low fuel warning, zone temperature out of range (e.g. during zone controlled operations), power loss, fail safe power loss or activation, pump failure, boiler temperature out of range, boiler high limit condition, boiler fault, manifold door open fault, out of range mix valve temperature, fill tank level, out or range cabinet temperature, extended fill pump operation, low water cut off signal enabled, or hose reel VFD errors, or a combination thereof. In yet a further option, the self diagnostics include detection of a data connection failure, for instance, when communication cannot occur with the system over a period of time. Still further, cabinet components can be monitored, including, but not limited to, conditions of relays, contactors, and power supplies.

In a further option, the system includes a GPS (Global Positioning Sensor). Using the GPS, a signal could be sent when the system is being moved, when it should be stationary. This would assist in preventing theft of the system.

When the parameters exceed or fall below a designated level, or a status of a component changes, this would trigger other events, such as notification to a user, for example, via email, telephone, internet, or a combination thereof. For the out of range parameters or component status changes that are detected, a possible cause and solution can also be provided. In addition, or in alternative to, the parameter or status change would involve a manual or automatic change to the components or certain parts of the system, for example over the internet.

The server 304 includes a control/monitor module and a machine-readable medium 312. In some example embodiments, the module remotely monitors and/or controls the heating system 110 and/or the heat distribution assembly 140. In some example embodiments, the machine-readable medium 312 includes tangible volatile and/or non-volatile media (e.g., read only memory (ROM), random access memory (RAM), magnetic disk storage media, optical storage media, flash memory devices, etc.). The machine-readable medium 312 can store content related to the controlling and monitoring of the heating system 110 and the heat distribution assembly 140.

While different embodiments can have different types of interfaces for the heating system 110 and the heat distribution assembly 140, the client devices 306 and the server 304, in some example embodiments, the interface may be Web-based, wherein the network 184 is the World Wide Web (WWW). The network 184 can be of different types, such as a local area network (LAN), other types of a wide area network (WAN), etc. In some example embodiments, the network 184 can be a combination of different networks that provide communication among the server 304, the heating system 110 and the heat distribution assembly 140 and the client devices 306. Further, the client devices 306, the heating system 110 and the heat distribution assembly 140 and the server 304 can communicate with the network 184 through wired and/or wireless communication. Moreover, to allow for increased security regarding the communications between the client devices 306, the heating system 110 and the heat distribution assembly 140 and the server 304, virtual private networks (VPNs) within the network 184 can be established between any two devices on the network (e.g., the heating system 110 and the heat distribution assembly 140 and the server 304, the server 304 and a client device 306, etc.).

In some example embodiments, network communication is based on one or more communication protocols (e.g., HyperText Transfer Protocol (HTTP), HTTP Secured (HTTPS), Real Time Messaging Protocol (RTMP), Real Time Messaging Protocol Secured/SSL (RTMPS), etc.). While the system 100 shown employs a client-server architecture, embodiments are not limited to such an architecture, and could equally well find application in a distributed, or peer-to-peer, architecture system.

As described above, the heating system 110 and the heat distribution assembly 140 heats the ground or concrete, monitors temperature of the ground or concrete, etc. In some example embodiments, the monitoring system 180 in the server 304 remotely controls the heat being generated by the heating system 110 and the heat being distributed by the heat distribution assembly 140, using control signals that are transferred from the monitoring system 180 to the heating system 110 and the heat distribution assembly 140 through the network 184. In some example embodiments, the monitoring system 180 monitors the operations of the heating system 110 and/or the heat distribution assembly 140. For example, the monitoring system 180 can receive communications on the target temperature, the current temperature, temperatures outside of a predetermined range, pressures within the system, power to the system, failures modes, etc. Moreover, the monitoring system 180 can receive communications from the heating system 110 and the heat distribution assembly 140 if certain events occurred. For example, if the ground or concrete heating unit is not operating correctly, if the target temperature is reached, etc., the heating system 110 and the heat distribution assembly 140 can transmit a communication to the monitoring system 180 over the network 184.

Further, the monitoring system 180 can transmit communications to any or all of the client devices 306, or the client devices 306 can contact the system 180 to obtain information. For example, the monitoring system 180 can transmit periodic reports on the operations of the heating system 110 and the heat distribution assembly 140, transmits a communication if certain events occur (as describe above), etc. In a further option, a final report of system/job operations and performance can be generated. In some example embodiments, the client devices 306 are Personal Digital Assistants (PDAs) configured for receiving and transmitting email and text message communications. Accordingly, the monitoring system 180 can transmit these reports/communications to the client devices 306 via emails and text messaging. Also, in some example embodiments, the client devices 306 control the monitoring system 180. Accordingly, the client devices 306 can monitor/control the heat assembly and heat distribution assembly through the monitoring system 180 executing on the server 304. In some example embodiments, the monitoring system 180 can be software, hardware, firmware or a combination thereof. In a further option, the client devices 306 can be used to generate reports on an as-needed basis, and/or a final report regarding system operations and/or system performance using the monitoring system 180 information.

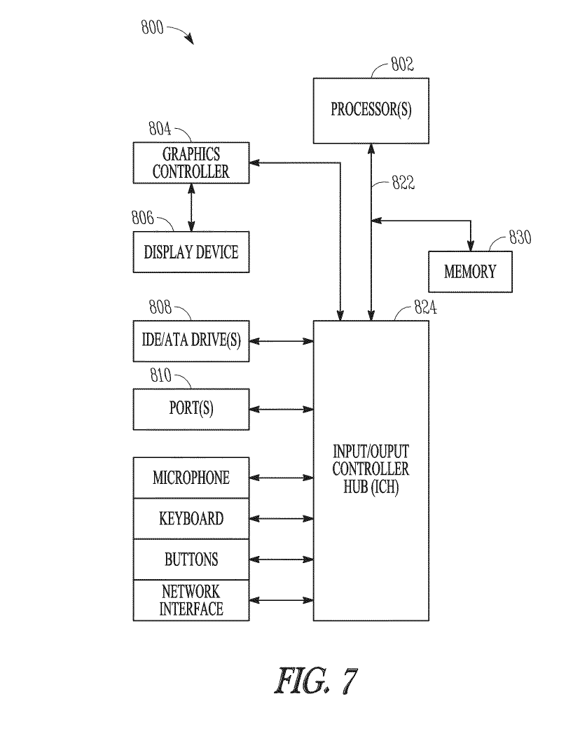

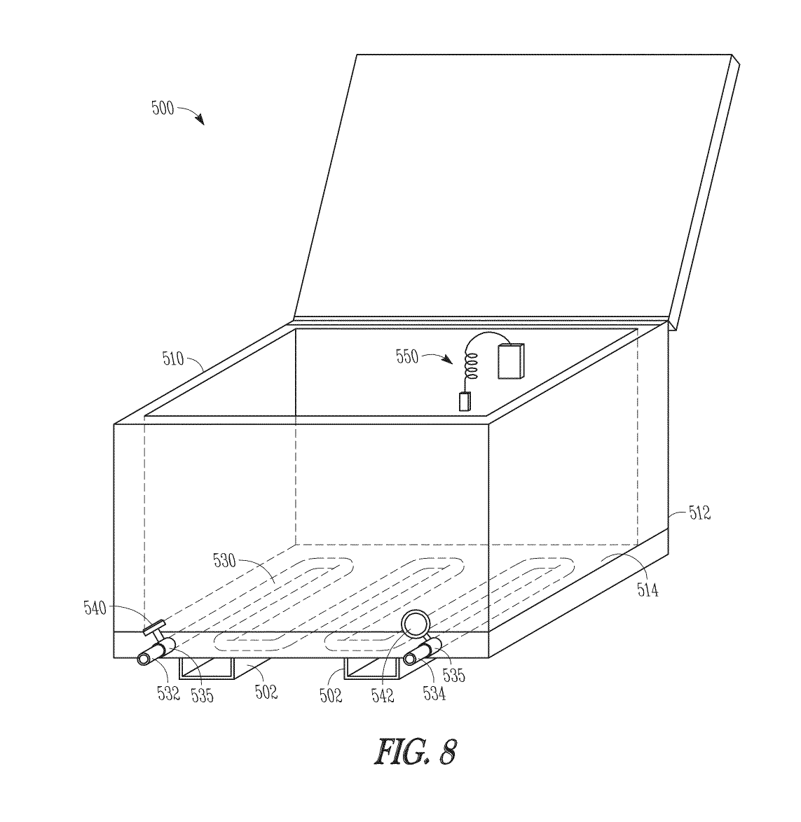

A detailed block diagram of an example computer environment, according to some embodiments, is now described. In particular, FIG. 7 is a block diagram of a computer system constructed in accordance with at least one embodiment. A computer system 800 can represent part of any one of the client devices 106, the heating system 110, the heat distribution assembly 140, the monitoring system 180 or the server 304.

As illustrated in FIG. 7, the computer system 800 includes processor(s) 802, a memory unit 830, processor bus 822, and Input/Output controller hub (ICH) 824. The processor(s) 802, memory unit 830, and ICH 824 are coupled to the processor bus 822. The processor(s) 802 may comprise any suitable processor architecture. The computer system 800 may comprise one, two, three, or more processors, any of which may execute a set of instructions to implement the various method embodiments.

The memory unit 830 may store data and/or instructions, and may comprise any suitable memory, such as a dynamic random access memory (DRAM). The computer system 800 also includes integrated drive electronics (IDE) drive(s) 808 and/or other suitable storage devices. A graphics controller 804 controls the display of information on a display device 806, according to some embodiments.

The input/output controller hub 824 provides an interface to I/O devices or peripheral components for the computer system 800. The ICH 824 may comprise any suitable interface controller to provide for any suitable communication link to the processor(s) 802, memory unit 830 and/or to any suitable device or component in communication with the ICH 824. For at least one embodiment, the ICH 824 provides suitable arbitration and buffering for each interface.

For some embodiments, the ICH 824 provides an interface to one or more suitable integrated drive electronics (IDE) drives 808, such as a hard disk drive (HDD) or compact disc read only memory (CD ROM) drive, or to suitable universal serial bus (USB) devices through one or more USB ports 810. For one embodiment, the ICH 824 also provides an interface to a keyboard 812, a mouse 814, a CD-ROM drive 818, one or more suitable devices through one or more FireWire® ports 816. For one embodiment of the invention, the ICH 824 also provides a network interface 820 though which the computer system 800 can communicate with other computers and/or devices.

In some embodiments, the computer system 800 includes a machine-readable medium that stores a set of instructions (e.g., software) embodying any one, or all, of the methodologies for described herein. Furthermore, software may reside, completely or at least partially, within memory unit 830 and/or within the processor(s) 802.

In a further option, a machine-readable medium including instructions, which when executed by a machine cause the machine to perform operations comprising monitoring at least one of temperature or pressure of one or more zones with a monitoring system via a network; receiving control signals from a server over a network; modifying at least one of temperature or pressure; and returning signal to the server indicating the temperature or pressure were modified.

While the machine-readable medium is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

In another embodiment illustrated in FIG. 8, an example of a field cure tester 500 is shown. In an option, the field cure tester 500 can be used with system 100 or is associated to test concrete before and during the curing process for which the system 100 is used, e.g. an ‘actual pour’. For example, the tester 500 can communicate with the system 100, and/or is fluidly coupled with the system 100. In another option, the system 100 can be used to control the tester 500, such as by regulating the temperature or monitoring the temperature. In another example, before the system 100 is used for a curing process, a test pour can be done where one or more cylinders of concrete can be poured into a form and allowed to cure, and then broken at certain time intervals. This will allow the cure time of the actual pour for the system to be determined. This will further allow for the psi of the concrete to be determined. In an example, the concrete cylinder is formed, tested, and found to have cured to 3000 psi in 72 hours, which can be used to predict the cure rate of the ‘actual pour’. In another option, the test cylinders of concrete are made during the curing process of the ‘actual pour’, and are optionally broken at certain time intervals. The test cylinders during the ‘actual pour’ can be used to do post tensioning of the concrete.

In an example embodiment, the field cure tester 500 includes an insulated enclosure 510, such as a box with insulation therein. The box includes a heating element such as a heat transfer hose 530. In an option, the heat transfer hose 530 can be disposed near a lower portion 512 of the insulated enclosure 510. The heat transfer hose 530 further includes at least one inlet 532 and at least one outlet 534, such as a supply and return for heating fluid to be disposed through the heat transfer hose 530. Couplers 535 are associated with the inlet 532 and the outlet 534, allowing for tubing or other structure to be connected with the heat transfer hose 530. In another option, a zone valve 540 is coupled with the supply, allowing for the flow rate of the heating fluid to be regulated. In yet another option, a temperature gauge 542 is associated with the return.

In yet a further option, the field cure tester 500 includes structure that allows for the tester 500 to be moved by equipment, such as, but not limited to, fork picks 502. In a further option, the field cure tester 500 includes structure such as one or more wheels allowing for the tester 500 to be moved manually and/or with other equipment.

A floor 514 is optionally disposed over the heat transfer hose 530, where the floor 514 is optionally removable from the insulated enclosure 510. In a further option, a temperature sensor 550 is included include the insulated enclosure 510 for sensing the temperature within the enclosure 510. In yet another option, a temperature sensor 550 is thermally coupled or associated with the concrete within the insulated enclosure 510 for monitoring the temperature of the concrete as it cures. In an option, the information regarding temperature can be wired or can communicate wirelessly with the system 100. In a further option, the tester 500 can be controlled by the system 100, for example to raise or lower the temperature, such as from a remote site, or generate reports on information regarding the tester. In yet another option, the system 100 provides the heating fluid for the tester 500, or the tester 500 has its own independent supply of heating fluid.

In an example use of the field cure tester 500, forms, such as cylindrical forms, are placed within the insulated enclosure 510, and are filled with material to be cured, such as concrete for a ‘test pour’. The insulated enclosure 510 is closed, and a heating fluid is flowed through the heat transfer hose 530. The temperature within the field cure tester 500 is monitored, for instance with a sensor within the insulated enclosure 510. The temperature can be optionally regulated by modifying the temperature and/or rate of the heating fluid through the heat transfer hose 530. At one or more predetermined time intervals, the forms of concrete are broken, tested, and evaluated for information. This information can be used to predict the cure rate of the ‘actual pour’.

A method and systems for heating, such as to heat ground or cure concrete have been described. Although the method and systems have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for elevating or controlling temperatures, the system comprising:
a heating system;
a heat distribution assembly operatively coupled with the heating system;
a monitoring system operatively coupled with the heat distribution assembly and the heating system; and
the monitoring system operatively connected with a network, where a third party can obtain information regarding the heating system or the heat distribution assembly via the network.

2. The system as recited in claim 1, wherein the monitoring system monitors at least one of temperature at one or more zones of the heat distribution assembly.

3. The system as recited in claim 2, wherein the monitoring system includes at least one of wireless or wired sensors associated with at least one zone.

4. The system as recited in claim 1, wherein the monitoring system includes information regarding a predictive cure rate.

5. The system as recited in claim 1, further comprising a field tester configured to be coupled with the heating system.

6. A system comprising:
a heating system;
a heat distribution assembly including one or more zones;
one or more sensors associated with at least one zone; and
a monitoring system in communication with the one or more sensors.

7. The system as recited in claim 6, further comprising a control system configured to control temperature at one or more of the zones.

8. The system as recited in claim 7, further comprising at least one wireless sensors or wired sensors associated with each zone.

9. The system as recited in claim 6, further comprising a remote manifold.

10. The system as recited in claim 6, further comprising two or more boilers adapted to modulate on and off.

11. The system as recited in claim 10, wherein the boilers are modulated on and off after a predetermined temperature has been sensed in the system.

12. A method comprising:
heating one or more zones with a system;
monitoring one or more zones of the system with a monitoring system, the system including a heating system, a heat distribution assembly, and one or more sensors associated with at least one zone;
sensing temperature at the one or more zones; and
monitoring includes monitoring temperature of the one or more zones.

13. The method as recited in claim 12, wherein monitoring includes monitoring via a network.

14. The method as recited in claim 13, wherein monitoring via the network includes accessing information over the internet.

15. The method as recited in claim 13, wherein monitoring via the network includes receiving one or more messages from the monitoring system.

16. The method as recited in claim 12, further comprising generating a report regarding temperatures at the one or more zones.

17. The method as recited in claim 12, further comprising monitoring components of the heating system.

18. The method as recited in claim 12, further comprising receiving an alert when a predetermined value is detected.

19. A method of thawing ground or curing material, the method comprising:
heating an area with a heating system, the area including one or more zones, heating the area includes distributing heat to the area with a heat distribution assembly;
monitoring at least one parameter of one or more zones with a monitoring system via a network;
receiving control signals from a server over a network;
modifying a temperature; and
returning signal to the server indicating the temperature was modified.

20. The method as recited in claim 19, wherein modifying includes selectively modifying at least one of temperature in each of the zones.

21. The method as recited in claim 19, wherein modifying includes modifying the temperature with a manifold.

22. The method as recited in claim 19, wherein modifying includes modifying the temperature with a remote manifold.

23. The method as recited in claim 19, wherein monitoring includes sensing information with a sensor, and sending a wireless signal regarding the information.

24. A method of thawing ground or curing material, the method comprising:
connecting tubing to a manifold;
circulating fluid through the tubing;
depressurizing the tubing with a depressurizing device; and
disconnecting the tubing from the manifold after the tubing is depressurized.

25. The method as recited in claim 24, wherein depressurizing the tubing includes opening an actuator, where the actuator is disposed over at least a portion of a tubing connection.

26. The method as recited in claim 24, further comprising closing an actuator of the depressurizing device prior to circulating fluid through the tubing.

27. The method as recited in claim 24, further comprising preventing disconnecting the tubing from the manifold until the tubing is depressurized.
